(19) United States
(12) Patent Application Publication
(10) Pub. No.: US 2011/0162252 A1
(43) Pub. Date: Jul. 7, 2011

(54) System & method for fishing

(76) Inventors: Jay Smith, Pacific Palisades, CA (US); Anson Sims, Granada Hills, CA (US)

(21) Appl. No.: 12/584,880

(22) Filed: Sep. 14, 2009

Related U.S. Application Data
(60) Provisional application No. 61/192,000, filed on Sep. 15, 2008.

(51) Int. Cl. A01K 97/00; A01K 99/00; H04N 7/18

(52) U.S. Cl. 43/4.5; 43/4; 348/81; 348/E07.085

(57) ABSTRACT

A fishing-rod assembly is provided for real-time observation of under-water fish behavior while fishing. The fishing-rod assembly includes a fishing rod or pole which supports a fishing line having a fish hook, a video camera, and a monitor for displaying video images of fish behavior in proximity to the fish hook. Also provided is a method for observing underwater fish activity while fishing. The method comprises focusing an underwater camera on an end of a fishing line, and displaying video images of fish activity at the end of the fishing line.

### RELATED PATENT APPLICATIONS

This application is a non-provisional patent application of provisional patent application, filed Sep. 15, 2008 and having Ser. No. 61/192,000. Benefit of the Sep. 15, 2008 date is hereby claimed.

### 1. FIELD OF THE INVENTION

Embodiments of the present invention are related to observing marine life or any underwater surroundings. More specifically, embodiments of the present invention provide a system and method for real time observation of underwater fish behavior while fishing.

### 2. BACKGROUND OF THE INVENTION

There has been a long felt need for fishermen to see the activity of marine life in proximity to bait or a lure. Conventional underwater-electronic cameras have recently made it possible for observing fish in the process of feeding on bait or biting lure. However, the problems of cost, weight and complexity have made it difficult to produce a low cost system that actually delivers an acceptable real time video which is usable to fishermen, and particularly younger children.

Therefore, what is needed and what has been invented is a fishing-rod assembly which can be produced cost effectively and posses the features of allowing a fisherman to view live real-time underwater fish activity in proximity to bait or a lure. More specifically, what is needed and what has been invented is a system and method of real-time observation of underwater-fish behavior while fishing. Embodiments of the present invention allow a fisherman to manage above-water fishing activity (e.g., reeling of line) at the same time underwater fish-bait interaction is being displayed.

### SUMMARY OF EMBODIMENTS OF THE INVENTION

Embodiments of the present invention provide a fishing-rod assembly for real-time observation of under-water fish behavior while fishing. The fishing-rod assembly broadly includes a fishing rod or pole which supports a fishing line having a fish hook, a video camera, and a monitor for displaying video images of fish behavior in proximity to the fish hook.

Embodiments of the present invention also provide a method for real-time observation of underwater fish activity while fishing comprising focusing an underwater camera on an end of the fishing line; and displaying video images of fish activity in proximity to the end of the fishing line.

These provisions, together with the various ancillary provisions and features which will become apparent to those skilled in the art as the following description proceeds, are attained by the methods and assemblies of the present invention.

### BRIEF DESCRIPTION OF THE DRAWINGS

FIG. 1 is a partial perspective view of a rod and reel assembly having a fishing rod secured to a reel housing containing a reel and a display monitor integrally secured to the reel housing.

FIG. 2 is another partial perspective view of a rod and reel assembly having a fishing rod secured to a reel housing which contains appropriate electronic components and a reel, and illustrating a rotatable crank coupled to the reel and protruding from the reel housing.

FIG. 3 is a side elevational view of a camera focused on a fish hook secured to the end of a fishing line.

FIG. 4 is an elevational view of an under-water embodiment of the camera assembly.

FIG. 5 is a schematic view of an embodiment of the invention illustrating the fishing rod and reel detached from the camera assembly and with eyeglasses containing the display screen.

FIG. 6 is a schematic view of an embodiment of the invention illustrating a floating camera assembly illustrating a conductor cable secured to a camera housed in a floating container.

FIG. 7 is a schematic view of an embodiment of the invention illustrating the wireless embodiment of the floating camera assembly which televises marine life images to a display device.

FIG. 8 is a schematic view of an embodiment of the wiring diagram for the fishing-rod assembly.

FIG. 9 is a partial vertical sectional view of a rear planar section of a pair of eyeglasses illustrating an eyeglass monitor where a user can view fish activity with an eye.

FIGS. 10-13 are schematic views of various embodiments of the wiring diagram for the fishing-rod assembly.

FIGS. 14-17 illustrate various perspective views of an eyewear-monitor assembly for being worn by a fisherman,

FIG. 18 is a perspective view of the leader assembly coupled to a camera housing which is coupled to a rod and reel.

FIG. 19 is a perspective view of the leader assembly coupled to a camera housing and comprising a weight, a leader attached to the weight, a hook, and a hook leader connected to the hook.

### DETAILED DESCRIPTION OF THE EMBODIMENTS OF THE INVENTION

In the description herein, numerous specific details are provided, such as examples of components and/or methods, to provide a thorough understanding of the embodiments of the present invention. One skilled in the relevant art will recognize, however, that an embodiment of the invention may be practiced without one or more of the specific details, or with other apparatus, systems, assemblies, methods, components, materials, parts, and/or the like. In other instances, well-known structures, materials, or operations are not specifically shown or described in detail to avoid obscuring aspects of the embodiments of the present invention.

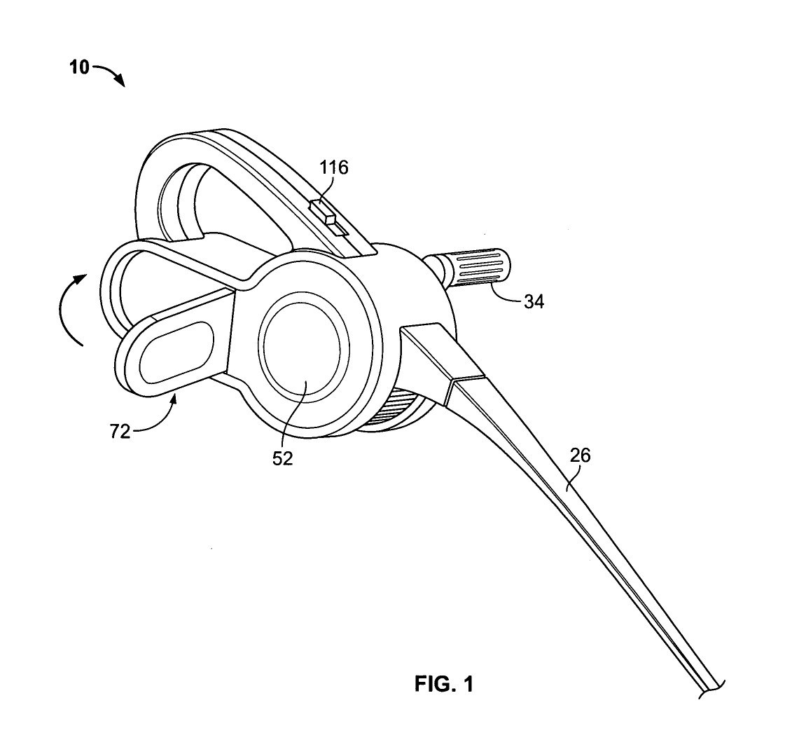

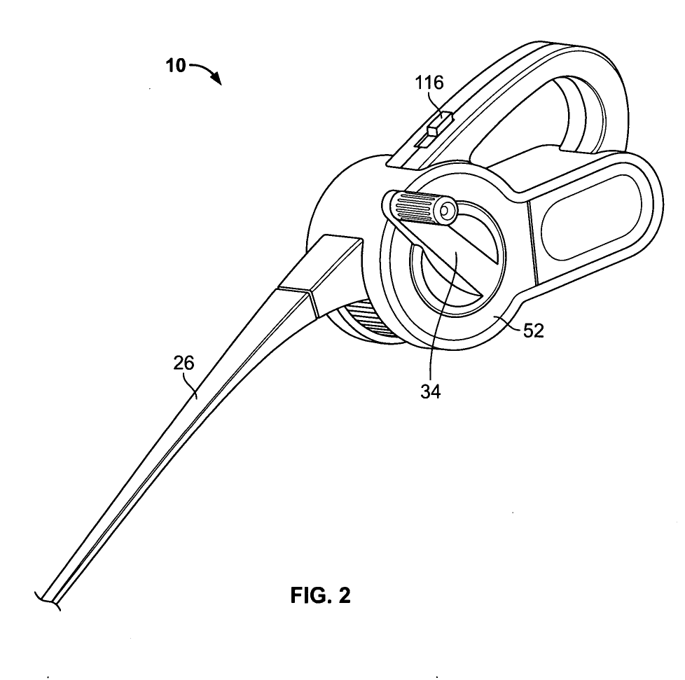

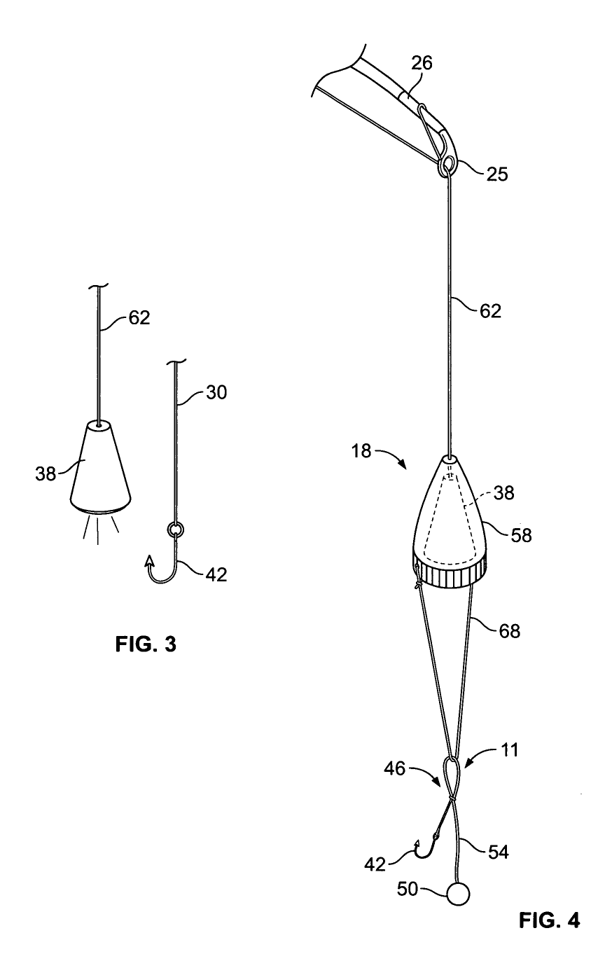

Referring in detail now to the drawings, wherein similar parts of the invention are identified by like reference numerals, there is seen a fishing-rod assembly 10 which includes a rod and reel assembly, generally illustrated as 14, and a camera assembly, generally illustrated as 18. The rod and reel assembly 14 includes a reel 22, and a rod (line support member) 26 engaged to the reel 22. A fishing line 30 extends from the reel 22, along the rod 26, and into water when in use. A reel crank 34 is engaged to the reel 22 for reeling the fishing line 30 as desired. The camera assembly 18 has a video camera 38 for capturing video images of fish and other marine life. A leader assembly 46 is engaged to the fishing line 30 along with a hook 42. It is to be understood that whenever hook is mentioned hereafter including the claims it is to mean a fish hook, a lure, a fish hook having bait, or any matter that they be used to attract fish or the like. As best shown in FIGS. 1 and 2, the reel 22 may be contained in a reel housing 52.

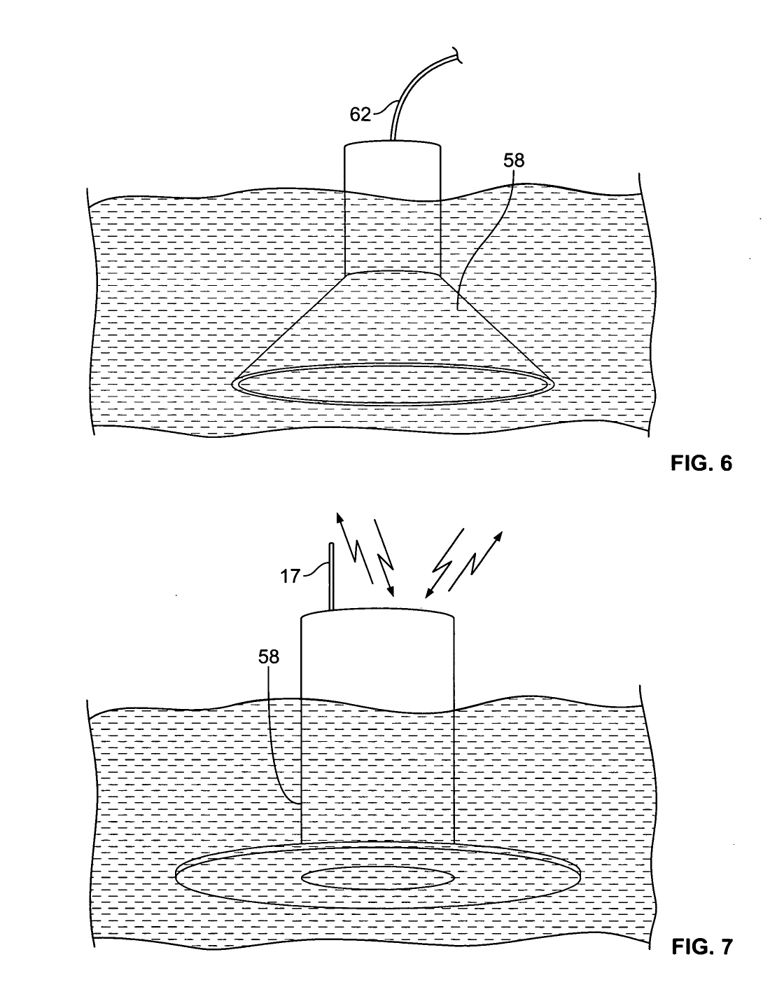

The camera 38 may be any suitable camera (e.g., those available at Omnivision) having sufficient resolution, auto-brightness, and field of vision, such as those cameras available at Omnivision Burton Drive, Santa Clara, Calif., 95054 and a web address: webmaster@omnivision.com. The camera 38 is housed in a waterproof camera housing 58 which would have a shape, size, buoyancy, weight, stability, and focusing capabilities that are tailored in accordance with the position and distance the camera 38 is to be located from the end of the fishing line 30. As illustrated in the drawings, the waterproof camera housing 58 may be the type that floats on the water (see FIGS. 6 and 7) or the type that is submersible (see FIG. 4). In describing various embodiments of the invention, where ever there is mention of video images being conducted or transmitted, it is to be understood the video images are being conducted or transmitted in a form which may be displayed on a suitable monitor.

In the embodiment of the invention illustrated in FIG. 4, there is seen the underwater embodiment of the camera assembly 18. For this embodiment of the invention, a power line 62 functions as a fishing line. The power line 62 is wrapped around the reel 22, similarly as the fishing line 30 wraps around the reel 22, and extends along the rod 26 and passes through an eyelet 25 secured to the rod 26, and hangs into the water such that the camera housing 58 (including the contained camera 38) is immersed in the water. As shown in FIG. 4, the power line 62 (conductor cable) passes into the housing 58 in a water-tight fashion and engages the camera 38. The power line or conductor cable 62 may be raised and lowered with the reel 22.

Attached to the bottom of the camera housing 58 and depending downwardly there from is a monofilament yoke 68 which supports the leader assembly 46 which comprises a weight 50, a leader 54 attached to the weight 50, a hook 42 and a hook leader 17 connected to the hook 42. As best shown in FIGS. 4 and 19, the yoke 68 hangs below the camera housing 58 as a single strand attached to the camera housing 58 at both ends by a frangible connection. A centering member 11 (see FIGS. 4 and 19) is coupled to the yoke 68. In an embodiment of the invention, the centering member 11 is a leader loop 15 (see. FIG. 19) which loops around the yoke 68 to make it self centering. The leader loop 15 may be defined by an end of the leader 54 formed into a loop. Alternatively, the leader loop 15 may be a member independent of the leader 54. In both embodiments the leader 54 hangs freely on the leader loop 15 and extends downwardly. The weight 50 is attached at the end of the leader 54 such that leader 54 and the weight 50 can swing back and forth, similarly as a pendulum swings. The weight 50 disposed in such a position keeps the camera 38 pointing at the weight 50. Preferably, the weight 50 is disposed at a sufficient distance away from the camera 38 to prevent the weight 50 from distorting or blocking the view of the camera 38. In an embodiment of the invention, the hook leader 17 connects at the juncture where the leader 54 couples to the leader loop 15 as best shown in FIG. 19. Thus, with the conductor cable 62 passing through the apex of the conical shaped camera housing 58 along with the leader assembly 46 and the yoke 68 coupled to the camera housing 58 as indicated above, the camera 38 is provided with the necessary stability and control to keep it focused on the bait or lure. The camera 38 may include one or more LEDs to illuminate the fishing area around the bait in very dark, deep waters, and may be used with or without a conventional bobber, depending on the user's preference.

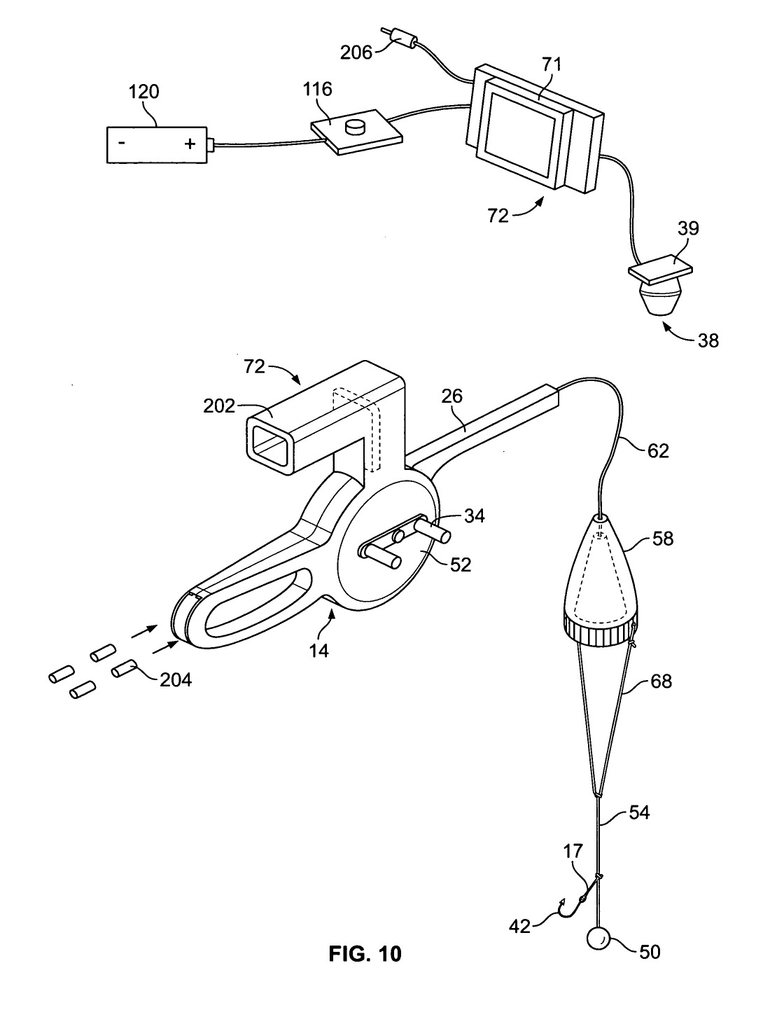

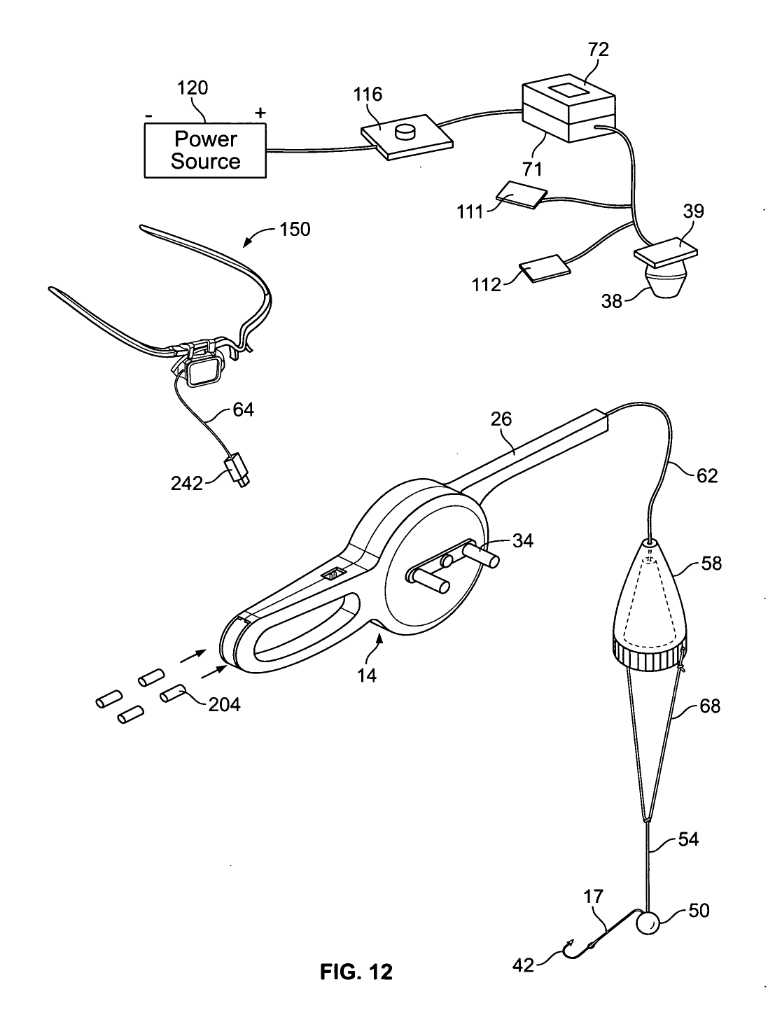

In another embodiment of the invention, the hook leader 17 connects to the leader 54 at the juncture where the weight 50 attaches to the leader 54, as best shown in FIG. 12. In yet another embodiment of the invention, the hook leader 17 adjustably connects to the leader 54 at a point between the point where the weight 50 attaches to the leader 54 and the point where the leader 54 connects with or is integrally formed with the leader loop 15, as best shown in FIG. 10. Thus, the hook leader 17 may be adjusted to connect (and be affixed) at any desired point along the leader 54.

Video images observed or captured by the camera 38 are caused to be displayed on a display monitor or screen 72. This allows a fisherman to conduct all of the regular activities associated with fishing while still providing a constant real-time video display of the fish activities around the bait or lure. The display monitor 72 may be of various types or forms. It is battery powered and may include the electronic components 90 for displaying video images.

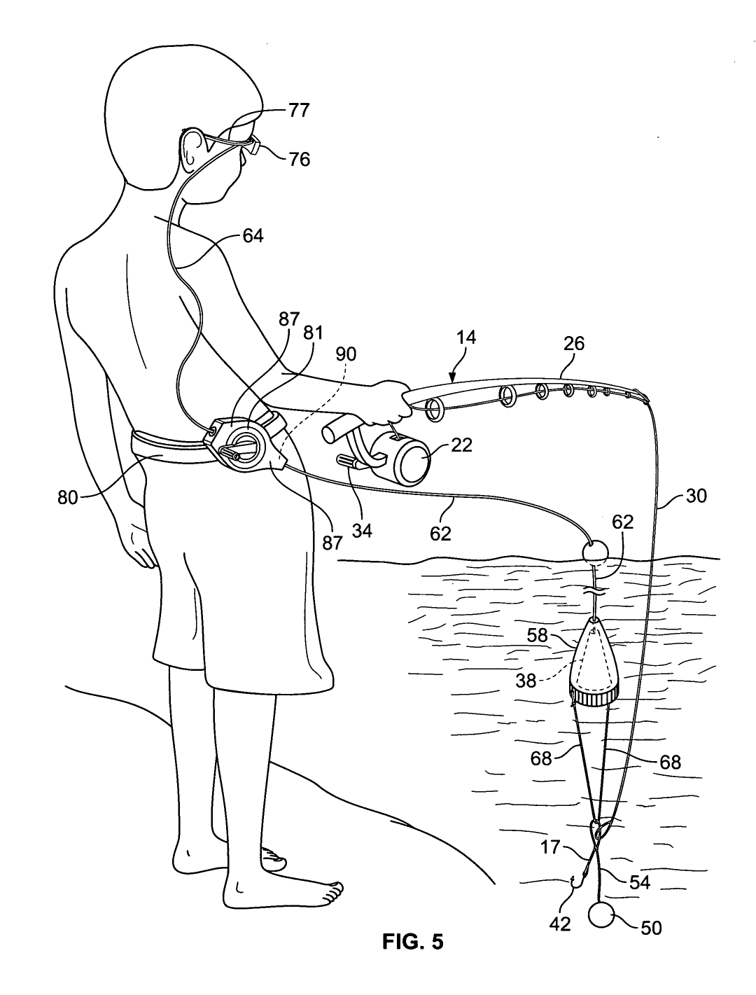

As shown in FIG. 5, the display (eyeglass) monitor 72 may be incorporated into a conventional pair of eyeglasses 76 to take the form of a very small flat panel (see FIG. 9) which supports a housing 78 that contains suitable electronic components 90. Eyeglass monitor 72 is contiguously mounted on one side of the eyeglasses 76 for viewing with one eye. As shown in FIG. 9, the eyeglasses 76 has a bridge section 75 and a pair of eyeglass spindles 77 extending from the rim of the eyeglass frame to respective ears.

As further shown in FIGS. 5 and 9, the camera-display combination is separate from the rod 26 and reel 22. The camera housing 58 (and the encapsulated camera 38) is floating on top of the water, as illustrated in FIG. 6. The fishing line 30 is coupled to the leader loop 15 at the juncture where the leader 54 is integrally bound with the leader loop 15, and at the (same) juncture where the hook leader 17 connects to the leader 54 and its associated leader loop 15. The conductor cable 62 extends from the camera 38, through the camera housing 58, and connects with housing 87 which may be attached to any apparel worn by a user, such as a belt 80. The housing 87 contains a conductor reel 81 for reeling conductor cable 62. In another embodiment of the invention, the housing 87 may house the electronic components 90 as opposed to the electronic components 90 being housed in housing 78. A conductor cable 64 extends from housing 87 to the monitor 72 being supported by the frame-like eyeglasses 76. In the embodiment of the invention where the electronic components 90 are contained within housing 87, conductor cable 64 functions as the power cable for conducting or transmitting video images from the electronic components 90 to the eyeglass monitor 72 for display, after the video images have been transmitted through conductor cable 62 to the electronic components 90. In the embodiment of the invention where the electronic components 90 are contained within housing 78, video images being transmitted through conductor 62 are continued being transmitted through conductor cable 64 to the eyeglass monitor 72 without having passed to and from electronic components 90.

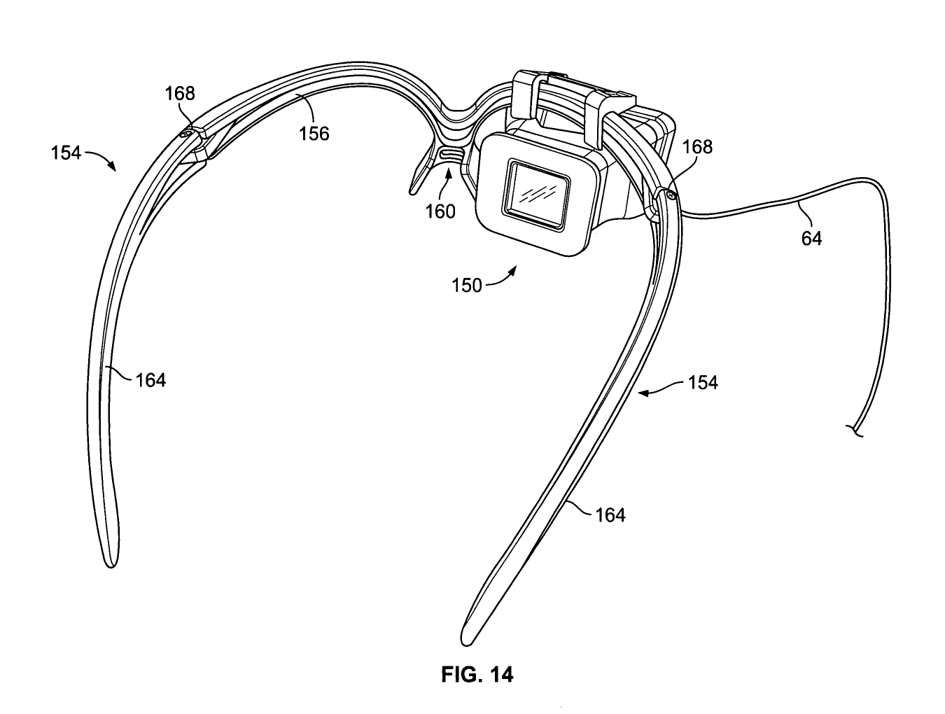

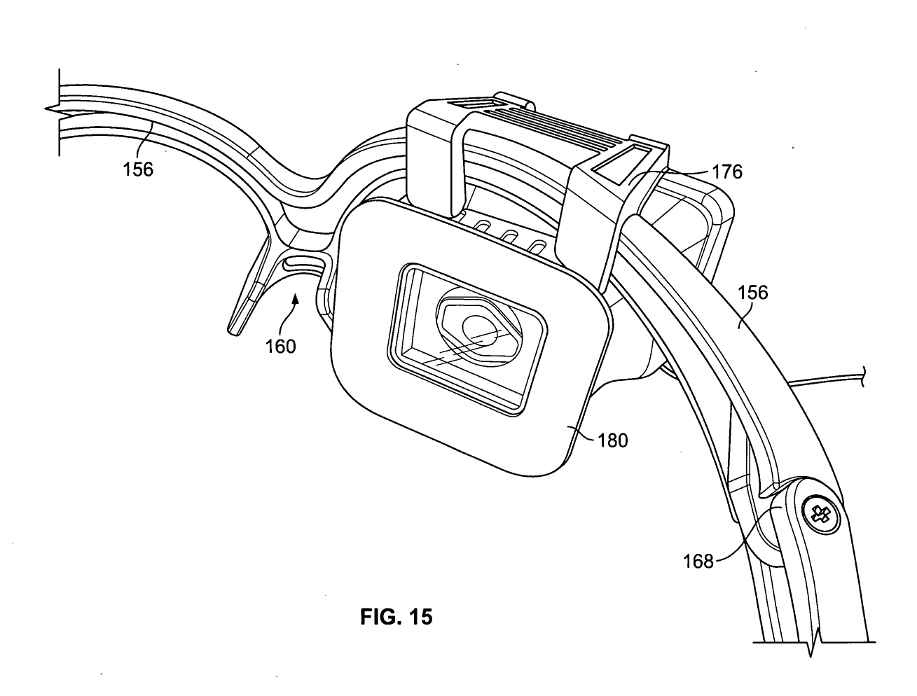

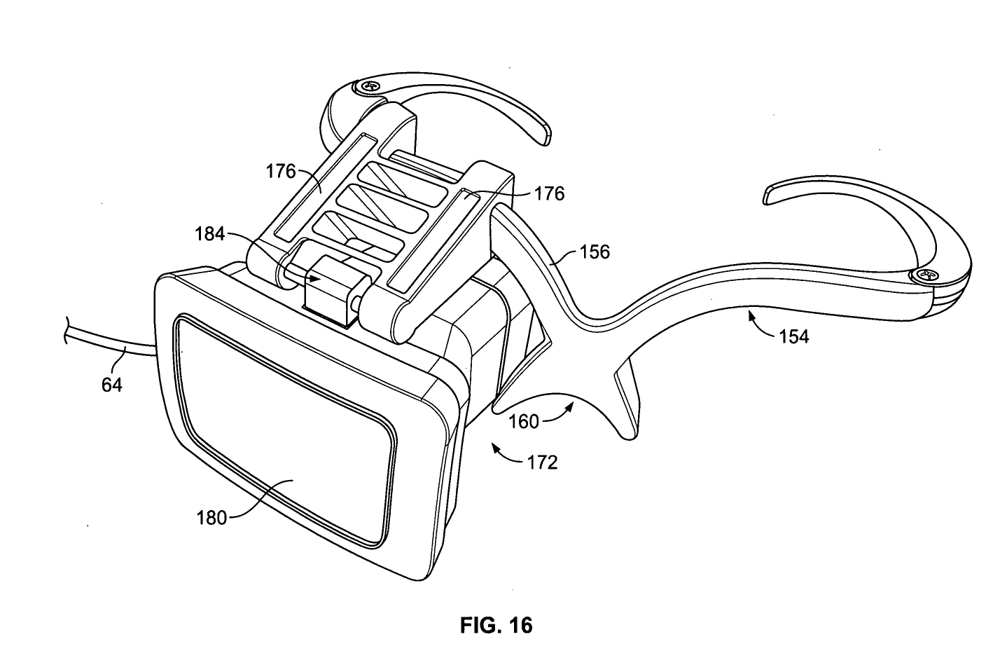

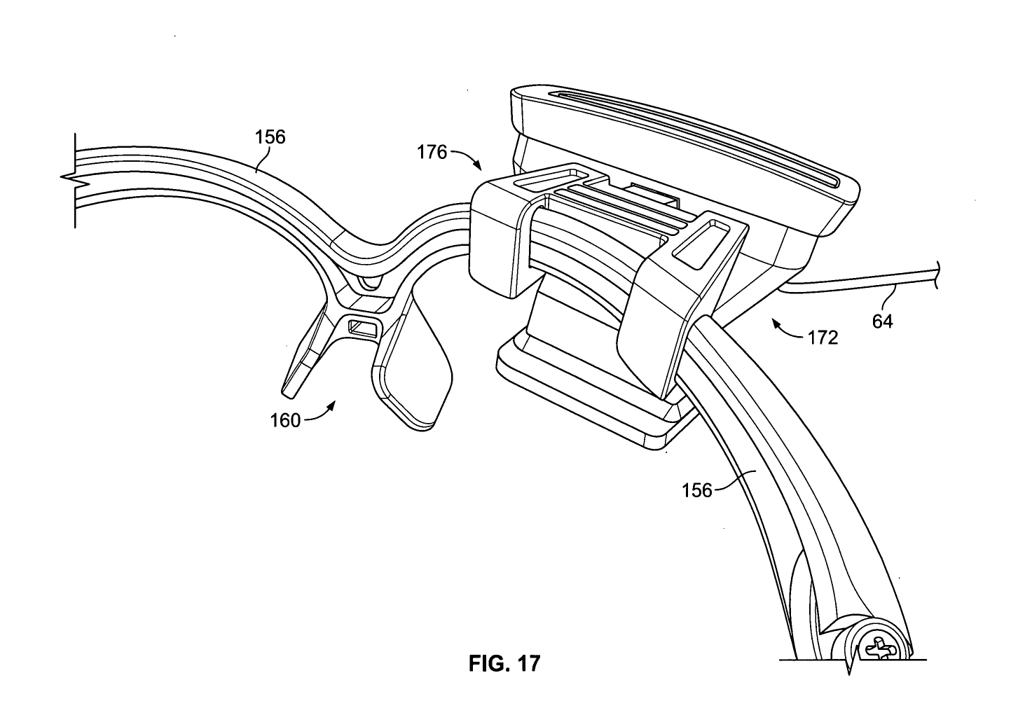

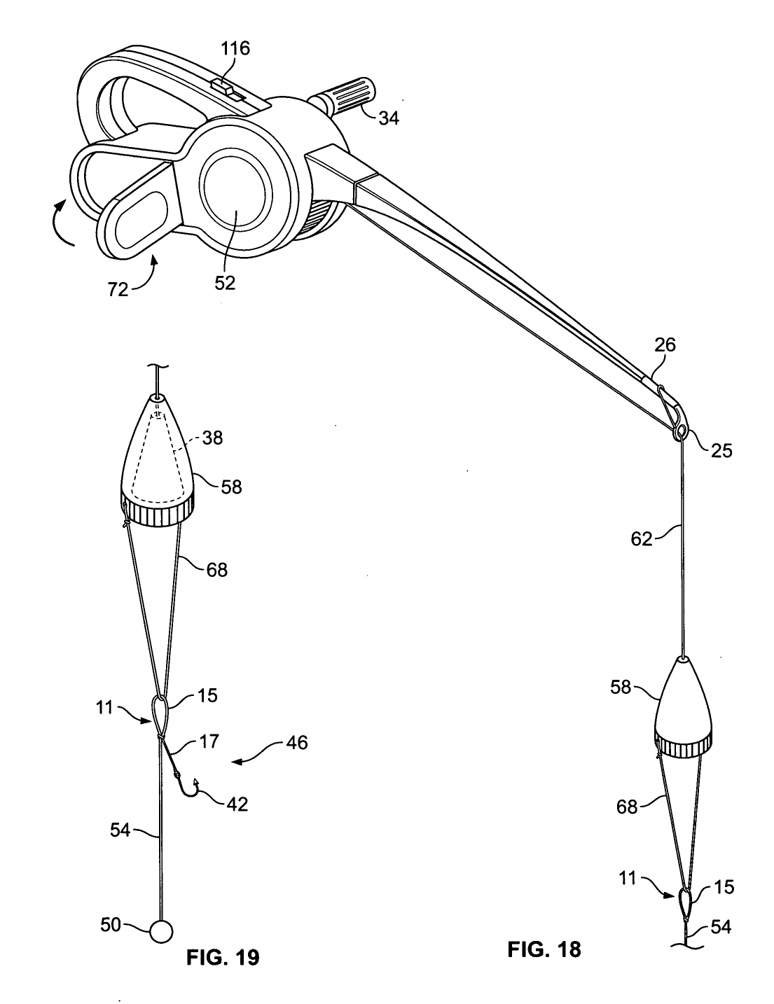

Referring now to FIGS. 14-17 there is seen another embodiment of the monitor 72. In this embodiment of the invention there is seen an eyewear-monitor assembly, generally illustrated as 150 and worn by a fisherman, similarly as how a pair of conventional eyeglasses are worn. The eyewear-monitor assembly 150 comprises a pair of opposed generally arcuate brackets 154-154 which are to engage the sides of a user's head. Each bracket 154 includes a proximal section 156 integrally bound with a bridge section 160 and a distal section 164 pivotally secured to the proximal section 156 at point 168. A monitor assembly 172 is supported by one of the proximal sections 156 of one of the arcuate brackets 154. The monitor assembly 172 has a monitor frame 176 attached to one of the proximal sections 156, and a monitor 180 is pivotally connected at point 184 to the monitor frame 176. The monitor 180 may be pivoted outward and away from an eye of a user for both-eye viewing, as best shown in FIG. 17. The conductor cable 64 couples to the monitor 180 for conducting video images to the monitor 180. As best shown in FIG. 12, when the electronic components 90 are contained within the camera housing 58, conductor cable 64 conducts video images from the electronic components 90 to the monitor 180 for display, after the video images have been transmitted through conductor cable 62 to the electronic components 90 within the camera housing 58.

Other types or form for the display monitor 72 may be a table top version which functions as a small TV, or a handheld monitor, similar to a handheld TV or portable video game. The display monitor 72 may be integrally formed with the reel housing 52, as best shown in FIG. 1. In this form, the monitor 72 is capable of being pivoted open and closed as illustrated. The spirit and scope of the present invention includes the use of additional monitors 72 (e.g., additional eyeglass monitors) which couple to conductor cable 62 such that the video images may be viewed by more than one person.

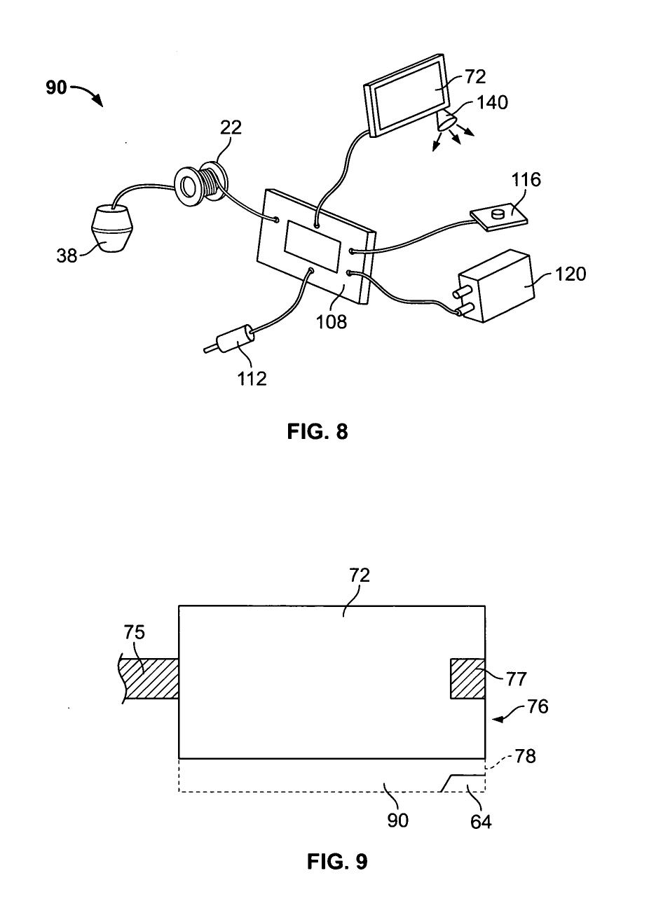

As previously indicated, the fishing-rod assembly 10 employs the suitable interface-electronic components 90 for operating various embodiments of the invention. As best shown in FIG. 8, components may include a printed circuit board (PCB) 108 (or encoder board) having layers of printed circuits coupled to the camera 38 and the monitor 72, and a power source (e.g., battery) 120 for furnishing appropriate power to the PCB 108 for operating the camera 38 and the monitor 72. In a preferred embodiment of the invention, the power voltage/source for transmitting visual images preferably ranges from about 3 volts to about 12 volts, more preferably from about 3 volts to about 7 volts, most preferably from about 3 volts to about 6.5 volts. An on/off switch 116 may be conveniently placed for closing and opening the circuit from the power source 120 to the PCB 108 which receives and transmits video images in appropriate form from the camera 38 to the monitor 72. A video-out jack 112 may be connected to the PCB 108 for providing an outlet to which other video devices may be coupled, such as another monitor 72. The video-out jack 112 may be a slip ring two-line plug in a jack coupled to the PCB 108. The PCB 108 functions as an intermediary between the camera 38 and the monitor 72. Any fish or other marine life on which the camera 38 is focused is displayed on the monitor 72. Thus, the fishing-rod assembly 10 of the present invention allows a fisherman to view live real-time underwater fish activity, such as in proximity to bait or a lure.

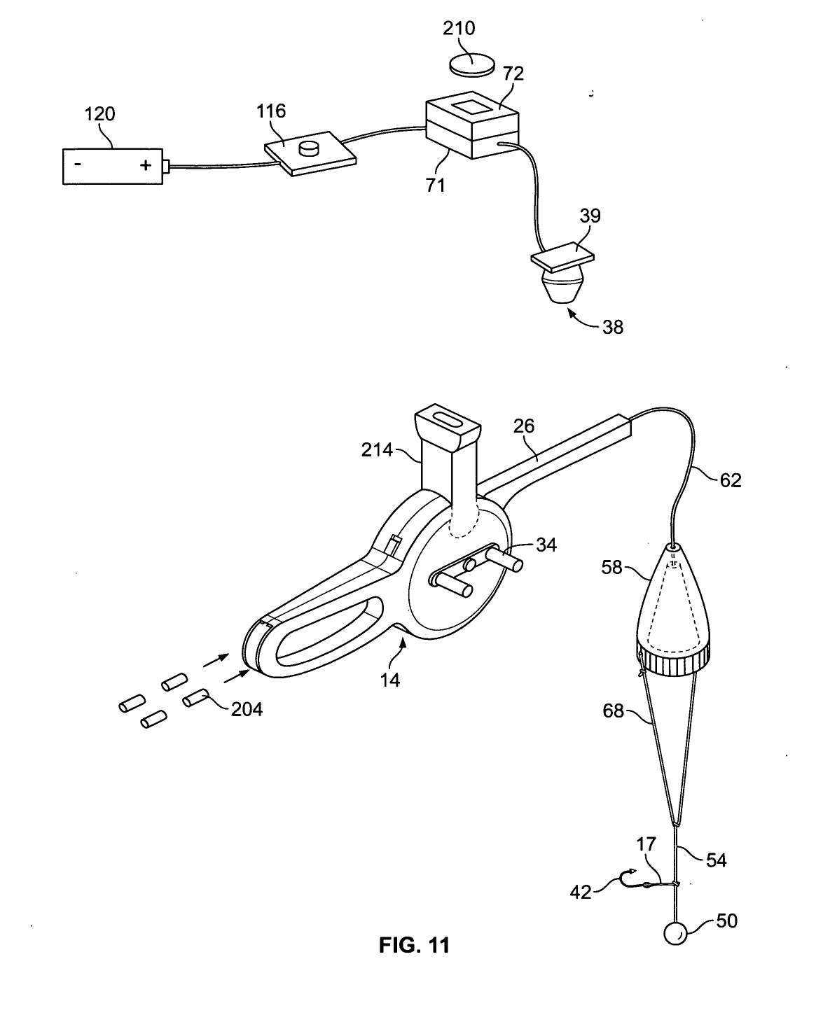

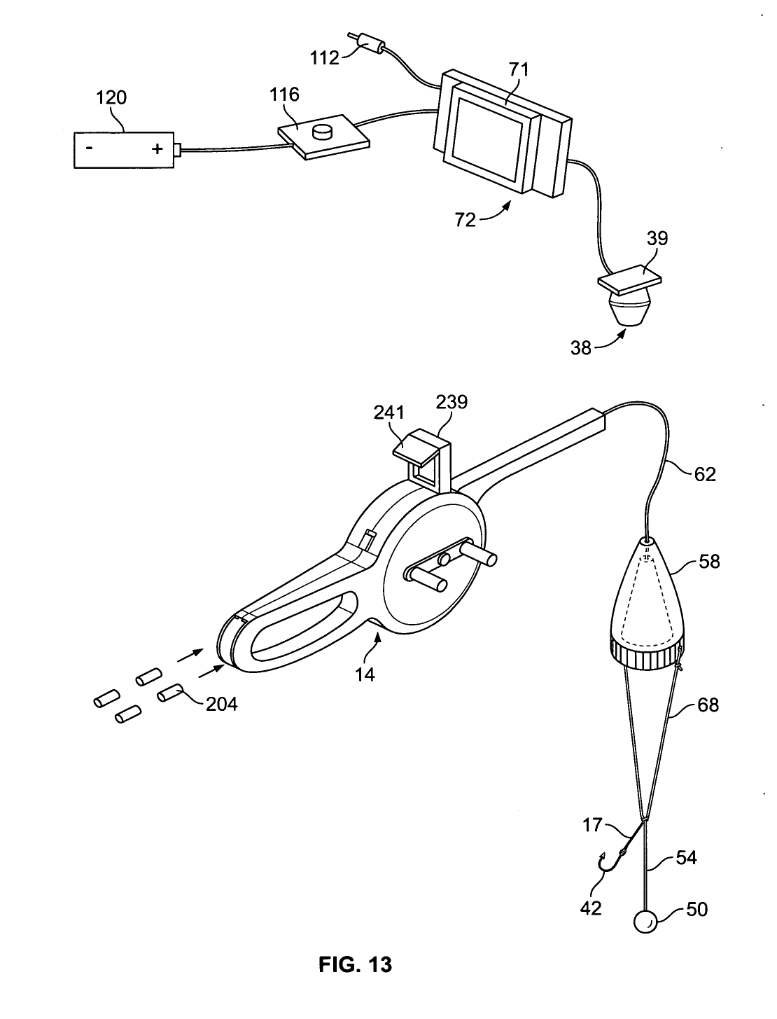

Referring now to FIGS. 10-13 there are seen further embodiments of a rod and reel assembly 14 and interface electronic components 90. Each camera 38 has an associated camera PCB 39, and each monitor 72 has an associated PCB 71. In FIG. 10 the reel camera 38 has a monitor light-reduction tunnel 202 along with batteries 204 for operation. A video-out jack 206 is provided with the monitor 72 for recording purposes. There is seen in FIG. 11 a miniature video display 72 having an eye piece lens 210, and a pivoting ocular eyepiece 214 for the reel housing 52. In FIG. 12 conductor 64 is provided with a male plug 242 for coupling the eyeware monitor assembly 150 to the reel housing 52 where the electronic components 90 are housed. A video-in jack 111 is coupled to the monitor 72. In FIG. 13 a video/monitor display 239 is provided with a visor 241 and is supported by the reel housing 52.

Embodiments of fishing-rod assembly 10 for the present invention may include a wireless connection between the camera 38 and the monitor 72. By way of example and as shown the FIG. 7, where the camera housing 58 is floating on water, antenna 17 is coupled to the camera 38 and extends through the camera housing 58 to enable video images to be wirelessly transmitted from the camera 38 to a monitor 92. For this embodiment of the invention, appropriate electronic devices and components would be associated with the antenna 17 and the camera 38, as well with the monitor 72, to allow wireless transmission of video images.

In other embodiments of the present invention, the electronic components comprise highly integrated semiconductor components, such as a microprocessor, for coordinating and controlling the fishing rod-assembly and activities on the surface. The microprocessor may be any suitable microprocessor, e.g., one or more general or special purpose processors, such as a Pentium®, Centrino®, Power PC®, and digital signal processor (“DSP”).

Further embodiments of the present invention include the features of recording the video images and/or audio signals/sounds of fish activity in proximity to the hook 42. A suitable connection housing (not shown in the drawings) would be provided for containing the recording/audio equipment. The connection housing may be included in the reel housing 52 or be in a separate container. The ability to record underwater sound and/or record video images would use appropriate electrical components or devices, such as, by way of example only: (i) built-in audio out and video out for an external recorder (with or without internal recording capability); (ii) analog or digital features; (iii) build-in internal digital recording capability for video/audio chips; (iv) outlets such as AV-out, USB out; and (v) memory storage, such as removable flash memory chips, or other techniques. Audio sounds may be emitted from a speaker 140 (see FIG. 8) for the fisherman to hear the underwater sounds of the fish activity as the fisherman is viewing the video images. The speaker 140 may be built into the monitor 72, particularly if it is an eyepiece monitor 72. This would allow use of the same conductor line (e.g., connector cables 62 and 64) for the audio emitter and monitor 72.

While embodiments of the present invention have been illustrated with the fishing-rod assembly having a camera and display screen, it is to be understood that the spirit and scope of the present invention includes other devices associated with the fish-rod assembly. Also, embodiments of the present invention are not to be limited to any particular use. Thus, the fishing-rod assembly 10 of the present invention may be used in any fishing application, such as for drop-line fishing off a dock or pier. If the fish hook 42 is removed, the fishing-rod assembly 10 may be used for only observing fish. Conventional rods may be retrofitted with the fishing-rod assembly.

Reference throughout this specification to “one embodiment”, “an embodiment”, or “a specific embodiment” means that a particular feature, structure, or characteristic described in connection with the embodiment is included in at least one embodiment of the present invention and not necessarily in all its embodiments. Therefore, the respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of the illustrated embodiments of the present invention and are to be included within the spirit and scope of the present invention.

Therefore, while the present invention has been described herein with reference to the particular embodiments thereof, a latitude of modification, various changes and substitutions are intended in the foregoing disclosures, and it will be appreciated that in some instances some features of the embodiments of the invention will be employed without the corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. An under-water camera assembly for fishing, comprising:
(a) a camera housing;
(b) a camera disposed in the camera housing;
(c) a yoke assembly coupled to the camera housing;
(d) a centering member supported by the yoke assembly;
(e) a weight leader supported by the centering member;
(f) a weight member attached to the weight leader;
(g) a hook leader coupled to the weight leader; and
(h) a hook secured to the hook leader.

2. The under-water camera assembly of claim 1 wherein said centering member comprises a loop.

3. The under-water camera assembly of claim 1 additionally comprising a power conductor connected to the camera for conducting video images for display.

4. The under-water camera assembly of claim 1 wherein said hook leader is adjustably coupled to the weight leader such that the hook leader may be attached to the weight leader at any desired point along the weight leader.

5. The under-water camera assembly of claim 1 wherein said yoke assembly comprises a looped line having its ends connected to the camera housing.

6. The under-water camera assembly of claim 5 wherein said yoke assembly comprises a monofilament line having its ends connected to the camera housing.

7. The under-water camera assembly of claim 3 additionally comprising a line-support member engaged to the power conductor.

8. The under-water camera assembly of claim 1 additionally comprising a line-support member and reel assembly coupled to the camera.

9. A fishing-device assembly for real-time observation of under-water fish behavior while fishing comprising:
(a) a line-support member;
(b) a power line member supported by the line-support member;
(c) an camera assembly coupled to the power line member;
(d) a monitor assembly coupled to the power line member for displaying under-water fish behavior;
(e) a yoke assembly coupled to the camera assembly;
a centering member supported by the yoke assembly;
(g) a weight assembly supported by the centering member; and
(h) a hook assembly supported by the centering member.

10. The fishing-device assembly of claim 9 wherein said camera assembly comprising a floating camera assembly.

11. The fishing-device assembly of claim 9 wherein said monitor assembly comprises an eyewear-monitor assembly.

12. The fishing-device assembly of claim 9 additionally comprising an electronic assembly coupled to the monitoring assembly and to the camera assembly.

13. The fishing-device assembly of claim 9 additionally comprising a reel housing supporting said line-support member.

14. The fishing-device assembly of claim 9 additionally comprising a reel housing, a reel disposed in said reel housing and engaging the power line for reeling the camera assembly.

15. The fishing-device assembly of claim 11 additionally comprising a recording device coupled to the electronic assembly.

16. The fishing-device assembly of claim 13 wherein said monitor assembly is integrally bound to said reel housing.

17. A method for real-time observation of underwater fish activity while fishing comprising:
focusing an underwater camera on an end of a power line, said camera having disposed underneath thereof a yoke assembly, a centering member coupled to the yoke assembly, a hook leader adjustably connected to a weight leader, a hook connected to an end of the hook leader, and a weight connected to the end of the weight leader;
transmitting visual images through a power line; and
displaying video images.
